(19) United States
(12) Patent Application Publication
(10) Pub. No.: US 2013/0082446 A1
(43) Pub. Date: Apr. 4, 2013

(54) METHOD OF REPAIRING ROTATING MACHINE COMPONENTS

(71) Applicant: General Electric Company, Schenectady, NY (US)

(72) Inventor: Mark Dean Pezzutti, Mason, OH (US)

(73) Assignee: GENERAL ELECTRIC COMPANY, Schenectady, NY (US)

(21) Appl. No.: 13/629,105

(22) Filed: Sep. 27, 2012

Related U.S. Application Data
(60) Provisional application No. 61/541,844, filed on Sep. 30, 2011.

(51) Int. Cl. F02C 7/28; B23K 9/00; B23P 6/00

(52) U.S. Cl. 277/412; 29/888.011; 29/402.02

(57) ABSTRACT

An apparatus and a method for repairing a component of a gas turbine engine is provided. The method includes locating a damaged area of the component, preparing a portion of the component that includes the damaged area leaving a remaining portion of the component, welding at least one layer of material to the remaining portion, using a cold metal transfer (CMT) process, and removing excess material from the component to a predetermined dimension.

### BACKGROUND OF THE INVENTION

The field of this disclosure relates generally to turbine engine sealing assemblies and more specifically, to methods and apparatus for repairing a component of a gas turbine engine.

At least some known components within gas turbine engines are prone to wear and breakdown due to use within engines. As such, the effectiveness of the components can be significantly decreased due to the wear. This wear can be highly problematic for certain components, including those formed of a powder metal alloy as the powder metal alloy components are difficult to weld after wear has occurred.

### BRIEF DESCRIPTION OF THE INVENTION

In one embodiment, a method for repairing a component of a gas turbine engine includes locating a damaged area of the component, preparing a portion of the component that includes the damaged area leaving a remaining portion of the component, welding at least one layer of material to the remaining portion, using a cold metal transfer (CMT) process, and removing excess material from the component to a predetermined dimension.

In another embodiment, a method for repairing a seal tooth fabricated from a powder metal alloy includes locating a damaged area of the seal tooth, removing the seal tooth from a rotating shaft, rotating the shaft about a central axis, and welding at least one layer of material to the seal tooth, using a cold metal transfer (CMT) process during the rotating.

In yet another embodiment, a gas turbine engine seal tooth includes a first radially inner tooth portion including a root integrally formed with a shaft of the gas turbine engine and a distal end extending radially outwardly from the root, the first portion including a metal alloy material identical to a material of the shaft, and a second radially outward portion of the seal tooth formed using a cold metal transfer (CMT) arc weld process in a circumferentially and outwardly radially extending built up weldment layered onto the distal end.

### BRIEF DESCRIPTION OF THE DRAWINGS

FIG. 1 is a schematic illustration of a gas turbine engine in accordance with an exemplary embodiment of the present invention.

FIG. 2 is a side perspective view of a seal tooth assembly in accordance with an exemplary embodiment of the present invention and that may be used within the gas turbine engine shown in FIG. 1.

FIG. 3 is a flow chart of an exemplary method for repairing a gas turbine engine component, such as components of the rotor disk shown in FIG. 2.

FIG. 4 is a flow chart of an exemplary method for repairing a gas turbine engine component in accordance with another exemplary embodiment of the present invention.

### DETAILED DESCRIPTION OF THE INVENTION

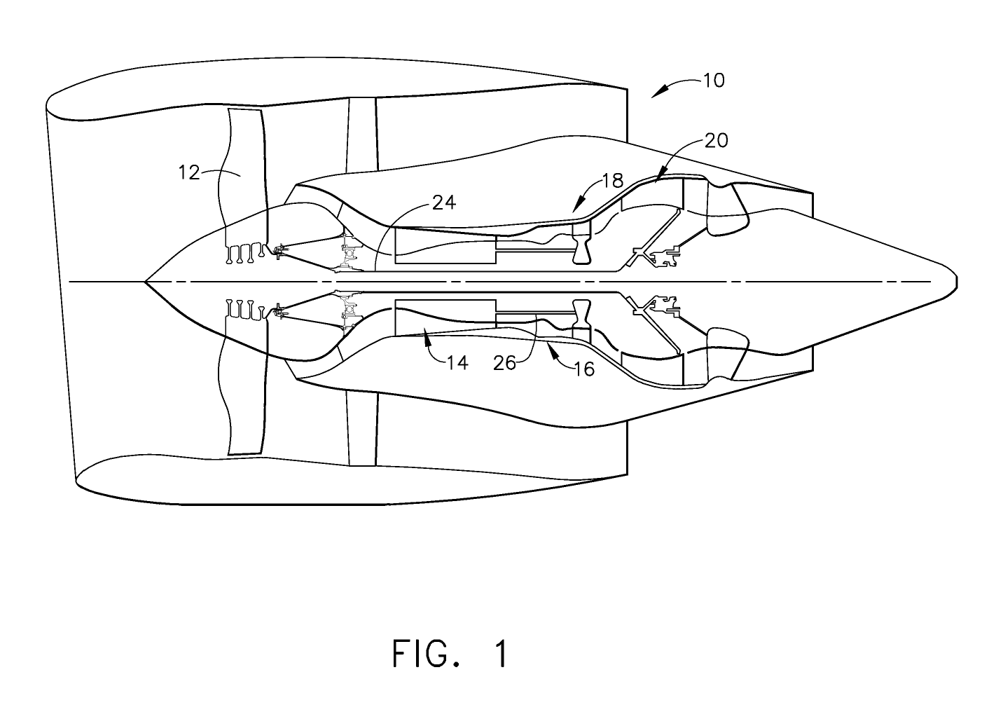

FIG. 1 is a schematic illustration of an exemplary gas turbine engine 10 that includes a fan assembly 12, a high pressure compressor 14, and a combustor 16. Engine 10 also includes a high pressure turbine 18 and a low pressure turbine 20. Fan assembly 12 and turbine 20 are coupled by a first rotor shaft 24, and compressor 14 and turbine 18 are coupled by a second rotor shaft 26.

During operation, air flows axially through fan assembly 12 and compressed air is supplied to high pressure compressor 14. The highly compressed air is delivered to combustor 16. Combustion gas flow (not shown in FIG. 1) from combustor 16 drives turbines 18 and 20. Turbine 18 drives compressor 14 by way of shaft 26 and turbine 20 drives fan assembly 12 by way of shaft 24.

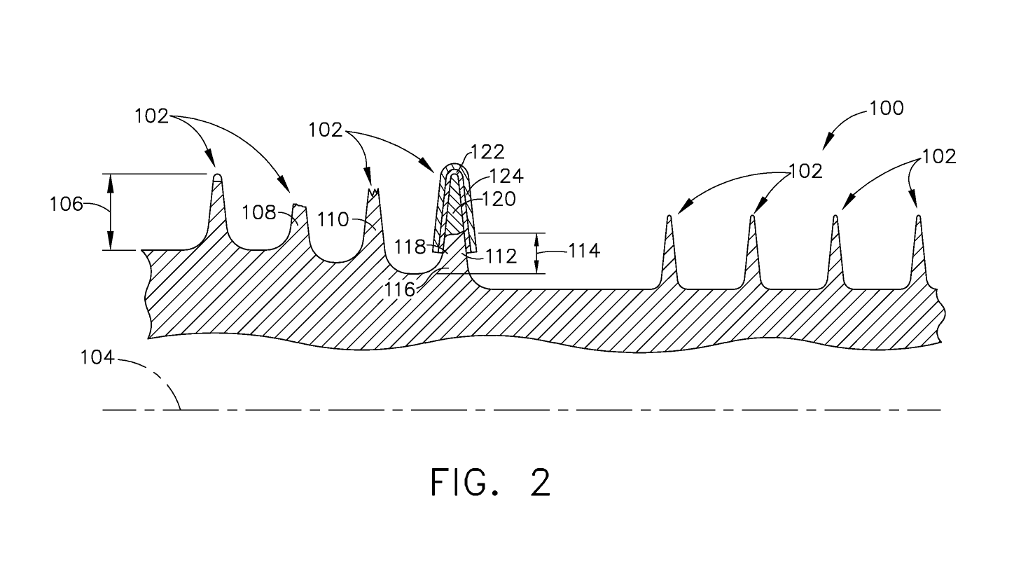

FIG. 2 is a side perspective view of a seal tooth assembly 100 in accordance with an exemplary embodiment of the present invention and that may be used within gas turbine engine 10 (shown in FIG. 1). In the exemplary embodiment, seal tooth assembly 100 may be integrally formed with a shaft (not shown in FIG. 2 or may be formed as a separate assembly and coupled to the shaft. As used herein, the term “integrally” refers to the component being one-piece and/or being formed as a one-piece component. Seal tooth assembly 100 includes rows of individual seal teeth 102 that extend radially outwardly from the shaft. The teeth are spaced axially along a rotational axis 104 of the shaft.

Each tooth has a predetermined height 106, which is generally constant for each tooth about the circumference of the tooth. Each tooth is configured to extend into proximity to or to engage a honeycomb seal portion (not shown in FIG. 2.) that extends radially inwardly from a casing (not shown in FIG. 2).

During operation, a tooth 108 may rub against the honeycomb sufficiently to cause an out-of-roundness of the tooth, for example, a diameter of the tooth may not be constant from point-to point around the circumference of the tooth. Alternatively, a tooth 110 may become chipped, for example, when a small portion of the tooth breaks free of the tooth. In either such case, seal tooth assembly 100 operates less efficiently by permitting a gas stream to escape through a gap created by the out-of-roundness or chipped area.

After a repair from an out-of-roundness condition, or a chip or a crack to any of seal teeth 102, a repaired seal tooth 112 may include a first radially inner tooth portion 114 including a root 116 integrally formed with the shaft and a distal end 118 extending radially outwardly from root 116. In the exemplary embodiment, first portion 114 is formed of a metal alloy material that is identical to a material of the shaft. In various embodiments, first portion 114 is formed of a material that is different from the material of the shaft. In other various embodiments, seal tooth assembly 100 is formed separately from the shaft and coupled to the shaft. A second radially outward portion 120 of seal tooth 112 is formed using a cold metal transfer (CMT) arc weld process in a circumferentially and outwardly radially extending built up weldment layered onto distal end 118. In various embodiments, first portion 114 is formed of a chrome alloy steel, a nickel base alloy, a titanium base alloy, an iron base alloy or combination thereof. In other embodiments, seal tooth 112 is formed of a powder metal alloy.

In some embodiments, seal tooth 112 includes a thermal barrier coating including a bond coat 122 applied to a surface of seal tooth 112 and a top coat 124 applied over bond coat 122.

In this example, second portion 120 is added to distal end 118 using a modified Gas Metal Arc Welding (GMAW) process, such as the cold metal transfer welding process. As known, cold metal transfer facilitates weld droplet formation. Cold metal transfer also utilizes less heat than other welding processes to facilitate reducing melt-back and a heat affected zone (HAZ). Both automated and manual cold metal transfer welding processes may be used to add the additional material of second portion 120 to distal end 118.

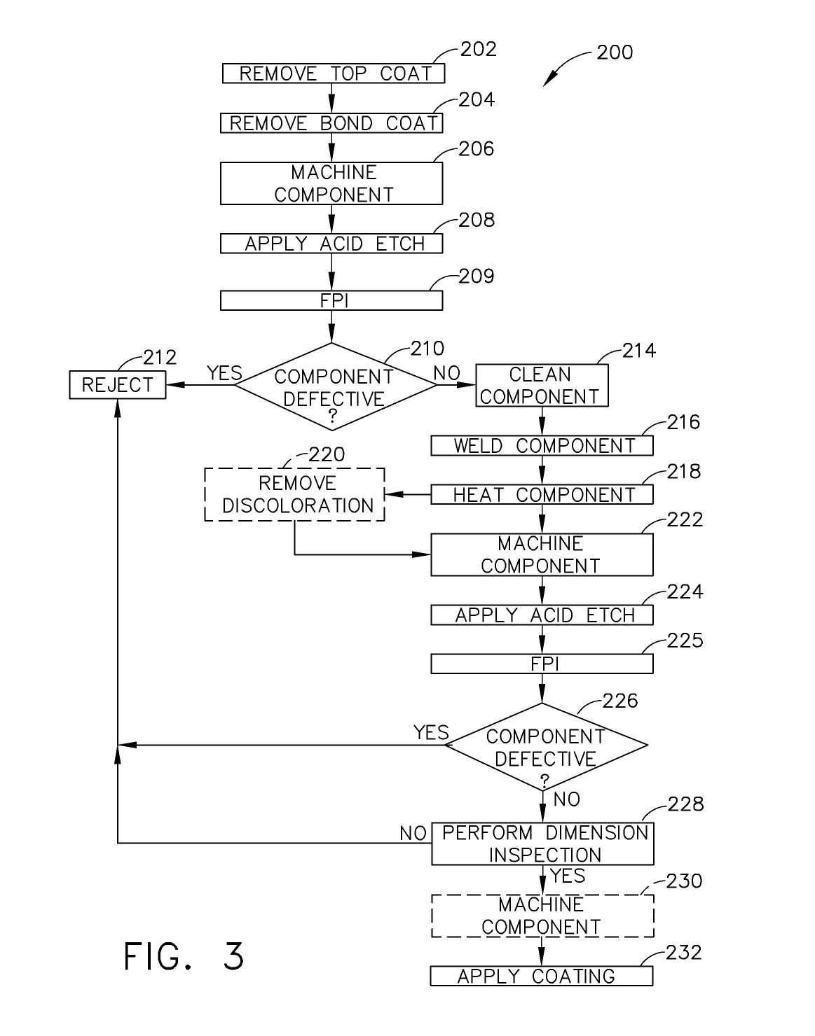

FIG. 3 is a flow chart of an exemplary method 200 for repairing a gas turbine engine component comprised of a powder metal alloy, such as seal teeth 102 shown in FIG. 2. Method 200 will be described for use with a nickel alloy seal tooth that has been worn through use within an engine. In the exemplary embodiment, a top coat on the seal tooth is removed 202. In one embodiment, the top coating is removed using a dry abrasive grit blast having an aluminum-oxide 220 grit media. Alternatively, any method of removing a top coat could be used that facilitates the repair of components as described herein. The seal tooth is then stripped 204 to remove a bond coat on the seal tooth. In one embodiment, the bond coat comprises at least 5% aluminum. In one embodiment a nitric acid wash having a 33-50 weight percentage is used to remove 204 the bond coat. Alternatively, any method of removing a bond coat could be used that facilitates the repair of components as described herein.

In the exemplary embodiment, after the bond coat is removed 204, the seal tooth is machined 206 to a pre-determined height to facilitate the repair. An acid etch is then applied 208 to component in preparation for a fluorescent penetrant inspection (FPI). In one embodiment, the acid etch includes ferric chloride, distilled and/or deionized water, and hydrochloric acid. Alternatively any acid etch could be used that prepares a component for an FPI. The fluorescent penetrant inspection is then performed to determine 210 if any defects exist that may compromise the integrity or quality of the seal tooth. In one embodiment, if substantial defects exist, the seal tooth is rejected 212. Alternatively, if substantial defects are determined 210 not to be present, the seal tooth is cleaned 214 to remove fluorescent penetrant. In one embodiment, the seal tooth is cleaned 214 using steam. Alternatively, any method of removing fluorescent penetrant can be used.

In the exemplary embodiment, the seal tooth is welded 216 to repair any damage or distress the seal tooth has incurred. In the exemplary embodiment, a cold metal transfer (CMT) arc weld is used to repair the damaged and/or distressed seal tooth. In one embodiment, during weld 216, portions of the seal tooth that have been worn from use are repaired and/or rebuilt. In such an embodiment, the seal tooth can be returned to its original size and shape. Alternatively, the seal tooth can be repaired to have any pre-determined dimensions that enable the seal tooth to function as intended. Using a CMT weld on the powder metal alloy seal tooth enables the seal tooth to have a longer useful life as many powder metal components are difficult if not impossible to repair and/or rebuild using other known welding methods.

In the exemplary embodiment, the seal tooth is heated 218 after weld 216. Heating 218 the seal tooth enables the seal tooth to release internal pressures and/or stresses that may have occurred during weld 216. In one embodiment, if the seal tooth is fabricated from a base material comprising Inconel 718, the seal tooth is heated to approximately 1400° F. for at least 1 hour to relieve any potential internal pressures and/or stresses. Alternatively, a seal tooth fabricated from a base material comprising Inconel 718 can be heated to 1150° F. for at least 2 hours to achieve a similar desired effect. In another embodiment, if the seal tooth is fabricated from a base material comprising Rene 88DT powder, the seal tooth is heated to approximately 1400° F. for at least 2 hours to relieve any potential internal pressures and/or stresses. In another embodiment, if the seal tooth is fabricated from a base material comprising Rene 65, the seal tooth is heated to approximately 1400° F. for at least 2 hours to relieve any potential internal pressures and/or stresses. In yet another embodiment, if the seal tooth is fabricated from a base titanium alloy such as, for example, Ti 6-4, the seal tooth is heated to in the range of 1000° F. to 2000° F. for at least 1 hour to relieve any potential internal pressures and/or stresses.

In one embodiment, any discoloration applied to the seal tooth during heat treatment 218 is removed 220. In the exemplary embodiment, discoloration is removed 220 using a dry abrasive grit blast including glass bead media. Alternatively, discoloration can be removed 220 by any process that will substantially remove discolorations from a heat treatment can be used. In the exemplary embodiment, the seal tooth is machined 222 to conform the seal tooth to a pre-determined height and width.

An acid etch is then applied 224 to component in preparation for a second fluorescent penetrant inspect (FPI). In the exemplary embodiment, a second fluorescent penetrant inspection is performed to determine 226 if any defects exist that may compromise the integrity or quality of the seal tooth. In one embodiment, if substantial defects exist, the seal tooth is rejected 212. Alternatively, if substantial defects are determined 226 not to be present, the seal tooth is inspected 228 to ensure the seal tooth corresponds to dimensions necessary to enable the seal tooth to function in a desired condition. If the seal tooth does not correspond to dimensions necessary to enable the seal tooth to function in a desired condition, the seal tooth is rejected 212.

If it is determined 228 that the seal tooth corresponds to dimensions necessary to enable the seal tooth to perform its intended function, a final machining of the seal tooth may be performed 230 and then a bond coating and top coating are applied 232 to the seal tooth. In the exemplary embodiment, a dry abrasive grit blast including 60-120 aluminum oxide grit media is used to prepare the seal tooth for a bond coating. After the grit blast, the bond coating and top coating are applied 232. In one embodiment, the bond coating and top coating are applied using a thermal spray. The thermal spray can include any thermal spray that will enable component to function as described herein including, but not limited to, plasma, flame, and electric arc. Alternatively, the bond coating and top coating can be applied in any way that enables sufficient adhesion of the coatings to the component.

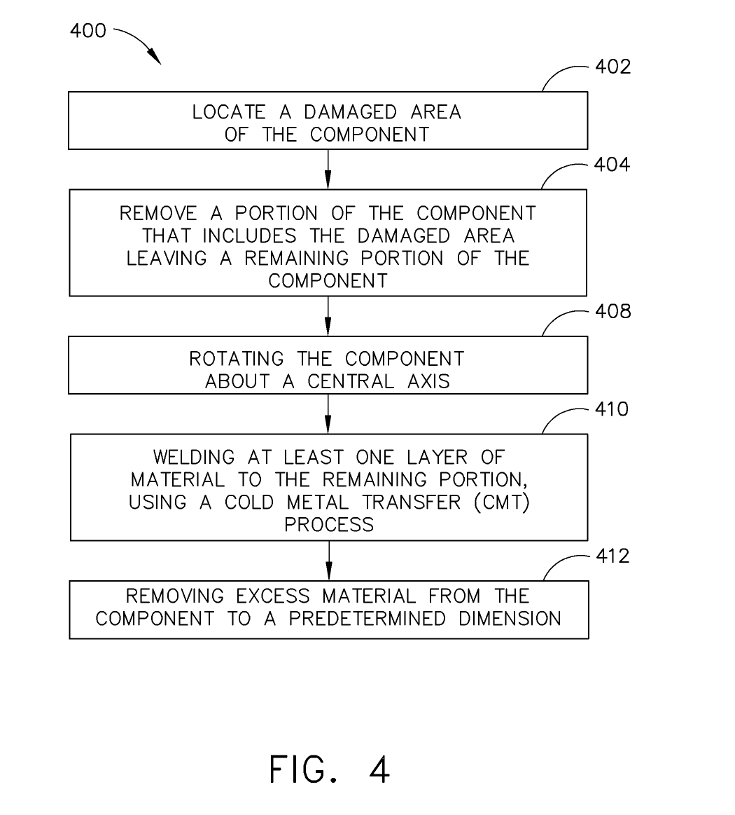

FIG. 4 is a flow chart of an exemplary method 400 for repairing a gas turbine engine component formed from a powder metal alloy in accordance with another exemplary embodiment of the present invention. In this exemplary embodiment, method 400 includes locating 402 a damaged area of the component, removing 404 a portion of the component that includes the damaged area leaving a remaining portion of the component, rotating 408 the component about a central axis, welding 410 at least one layer of material to the remaining portion, using a cold metal transfer (CMT) process, and removing 412 excess material from the component to a predetermined dimension.

The locating of a damaged area of the component may further include locating, for example, an out of roundness of the component or a chipped area of the component. An out-of-roundness may occur when the seal tooth impacts the turbine casing or honeycomb material that forms a portion of the seal assembly.

Method 400 includes removing excess material from the component to a predetermined outside diameter of the component. Such removal may occur using, for example, a grinding or machining process and is configured to remove the radially outer portion of the tooth down at least to the level of damage to the tooth, such that the welding rebuild process starts with a round tooth having a prepared edge to which the weld buildup is applied.

Method 400 may also include rotating the component about a central axis while removing the damaged portion of the component and during welding one or more layers of weldment to the component using a cold metal transfer (CMT) process. In various embodiments, the CMT process robotically controlled to position the weld head accurately and to control energy delivery to the weld site. The seal tooth, or other component, may include a powder metal alloy comprising a nickel based alloy, a titanium based alloy, or other alloys. Method 400 further includes restoring any coating that was removed from the component during the repair process such as applying a bond coat and/or thermal barrier coating to the component.

The above-described methods for repairing alloy components, including powder metal alloy components provide longer life to powder metallurgical alloy components. More specifically, repair methods such as those described above allow for repair by using CMT welding techniques where other welding techniques have been shown to be ineffective. As such, the above described method enables a powder metal alloy component to remain in use after wear that substantially affect a components effectiveness has occurred.

Exemplary embodiments of methods for repairing powder metal alloy components described above in detail. The methods are not limited to the specific embodiments described herein, but rather, components of apparatus and/or steps of the methods may be utilized independently and separately from other components and/or steps described herein. For example, the methods may be used with any powder metal alloy component, and are not limited to practice with only the seal teeth of a rotor disk as described herein. Further, the methods described above may be used with any powder metal alloy, and are not limited to practice with a nickel alloy as described above. For example the methods described above may be used with any powder metal alloy such as a nickel alloy (e.g., Rene 88DT).

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for repairing a gas turbine engine component formed from a superalloy material, said method comprising:
locating a damaged area of the component;
preparing a portion of the component that includes the damaged area;
welding at least one layer of material to the prepared portion, using a cold metal transfer (CMT) process; and
removing excess material from the component to a predetermined dimension.

2. The method in accordance with claim 1, wherein removing excess material from the component to a predetermined dimension comprises removing excess material from the component to a predetermined outside diameter of the component.

3. The method in accordance with claim 1, wherein locating a damaged area of the component comprises locating at least one of an out of roundness of the component and a chipped area of the component.

4. The method in accordance with claim 1, wherein preparing a portion of the component that includes the damaged area comprises removing a portion of the component using at least one of grinding and machining the component to remove an outer circumferential extent of the component down to an outside diameter that is less than an outside diameter to the damaged area.

5. The method in accordance with claim 1, further comprising rotating the component about a central axis while removing a portion of the component that includes the damaged area.

6. The method in accordance with claim 1, further comprising rotating the component about a central axis while welding at least one layer of material to the remaining portion, using a cold metal transfer (CMT) process.

7. The method in accordance with claim 1, wherein providing an alloy component of a gas turbine engine further comprises providing a nickel based alloy.

8. The method in accordance with claim 1, wherein providing an alloy component of a gas turbine engine further comprises providing a titanium based alloy.

9. The method in accordance with claim 1, further comprising applying a thermal barrier coating to the component.

10. The method in accordance with claim 1, wherein welding at least one layer of material to the remaining portion, using a CMT process comprises controlling the CMT process robotically.

11. A method for repairing a seal tooth fabricated from a powder metal alloy, said method comprising:
locating a damaged area of the seal tooth;
removing the seal tooth from a rotating shaft;
rotating the seal tooth about a central axis; and
welding at least one layer of material to the seal tooth, using a cold metal transfer (CMT) process during the rotating.

12. The method in accordance with claim 10, further comprising removing excess material from the component to a predetermined dimension.

13. The method in accordance with claim 10, further comprising removing a portion of the seal tooth that includes the damaged area leaving a remaining portion of the seal tooth.

14. The method in accordance with claim 10, further comprising mounting the seal tooth in a rotating support device.

15. A gas turbine engine seal tooth comprising:
a first radially inner tooth portion comprising a root integrally formed with a shaft of the gas turbine engine and a distal end extending radially outwardly from said root, said first portion comprising a metal alloy material identical to a material of the shaft;
a second radially outward portion of the seal tooth formed using a cold metal transfer (CMT) arc weld process in a circumferentially and outwardly radially extending built up weldment layered onto the distal end.

16. The seal tooth in accordance with claim 15, wherein said first inner tooth portion is formed of at least one of a chrome alloy steel, a nickel base alloy, a titanium base alloy, and an iron base alloy.

17. The seal tooth in accordance with claim 15, wherein a material forming the second portion is different than the material forming the first portion.

18. The seal tooth in accordance with claim 15, wherein the seal tooth comprises a thermal barrier coating comprising a bond coat applied to the seal tooth and a top coat applied over the bond coat.

19. The seal tooth in accordance with claim 15, wherein said seal tooth comprises a seal edge machined to a pre-determined dimension.

20. The seal tooth in accordance with claim 15, wherein said seal tooth comprises a powder metal alloy.
